(19) United States
(12) Patent Application Publication
(10) Pub. No.: US 2008/0105139 A1
(43) Pub. Date: May 8, 2008

(54) Container Comprising an Arched Bottom for Receiving Cooking Goods

(76) Inventors: Gerhard Kramer, Penzing (DE); Katharina Wallenwein, Landsberg (DE); Judith Imgram, Hanau (DE); Andrea Juergens, Kirchheim (DE); Michael Greiner, Freising (DE); Juergen Klasmeier, Buchloe (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/971,479

(22) Filed: Jan. 9, 2008

Related U.S. Application Data
(63) Continuation of application No. 10/513,117.

(30) Foreign Application Priority Data
Apr. 29, 2002 (DE) 10219065.8-16

(51) Int. Cl. A47J 37/07

(52) U.S. Cl. 99/450

(57) ABSTRACT

A container is provided for receiving cooing products to be cooked in a cooking chamber. A substantially circumferential upper rim is provided, sidewalls are provided, and lower region comprising a bottom. The bottom has at least one arch which is raised, at least a portion of which is towards the center of the container. At least one bottom rib is provided.

This application is a continuation application of U.S. patent application Ser. No. 10/513,117, which is the U.S. National Phase of International Application No. PCT/EP03/02605, having an international filing date of Mar. 13, 2003 and claiming priority to German patent application number 10219065.8-16, filed Apr. 29, 2002, the entire contents each of which are hereby incorporated herein by reference.

### BACKGROUND

The present disclosure relates to a container for receiving cooking products, particularly pre-conditioned cooking products, which are to be cooked, especially cooked to completion, in a cooking chamber suitable to be impinged upon by circulating hot air and/or steam, with said container comprising an essentially circumferential upper rim, a bottom of which is lowered relative to said rim, and side walls.

For cooking products to completion, in particular pre-conditioned cooking products such as pre-blanched French fries, potato croquettes, potato balls, potato wedges or the like, hanging trays in the form of granite enameled containers, CNS trays or perforated aluminum plates, for example, are currently in use, for instance in so-called combi-ovens suitable to use hot air as well as steam for cooking purposes (see “Handbuch ClimaPlus Combi”, 04/97, Rational Groβküchentechnik GmbH). These known hanging trays prevent the disadvantage that mostly only a single-layer load is applied in order to ensure that a region as large as possible of the surfaces of the cooking products can be in direct contact with the hot air during cooking to completion. Furthermore, such trays or hanging trays involve the danger that the surfaces of the cooking products which are in direct contact with a surface of the tray become roasted, similar to fried potatoes, with this roast effect being aggravated by the dripping of the frying fat.

The document U.S. Pat. No. 4,052,589 A describes stackable trays and drawers, respectively, with at least two receptacles to receive cooking products, more precisely to permit simultaneous cooking and/or cooling of preconditioned food portions.

The document DE 39 36 907 A1 discloses a mold for cooking baking or frying goods, in particular for fowl, fish and meat, in a baking oven. To ensure a homogenous cooking, the mold comprises an area for storing the baking or frying goods which is formed as a heat storing element and/or a hollow piece. At least the hollow piece comprises at least one air inlet opening leading into the hollow body.

The document DE 199 06 181 A1 concerns an ecological grill pan made of aluminum foil for receiving grill material, having the form of a shell with wavelike bottom formations and alternating depressions and raised embossments. Particular formations of through ventilation apertures are provided in the flanks of the raised formations to prevent the dripping of fat into a fireplace while forcing the circulation of air.

The document DE 198 60 009 A1 describes a container for receiving food in the form of a three-dimensional piece of wire mesh. The piece of wire mesh preferably comprises wavy bulges, conical, pyramid-shaped or corrugated uneven parts causing food to be cooked to assume a multitude of different positions relative to each other and/or to the piece of wire mesh. This permits in particular preventing a parallel contact between the food items and/or with a container wall.

The document WO 00/57709 describes an oven for maintaining cooking goods at temperatures suitable for serving or for cooking. This oven comprises multiple drawers in which containers for receiving food can be placed. These containers have a flat bottom, respectively.

According to WO 93/21807, a frying basket having a semicircular cross section suitable to rotate around an axis on its upper edge while being immersed into the frying fat, thus allowing the food items to float in it, can be used. This cooking device is said to be particularly easy to clean.

The document DE 297 24 257 U1 describes a baking tray for crisping up baguettes or the like, provided with multiple bottom cavities for receiving baguettes to be crisped up. The baguettes can be accurately placed in these bottom cavities so that they cannot change their position, even when the baking tray is inserted into the baking oven, thus preventing, for instance in the case of filled baguettes, that the fillings slip off onto the bottom of the baking tray. The bottom cavities allow for an accurate position and reliable fixing of the baguettes on the baking tray.

The document U.S. Pat. No. 5,487,330 discloses a pan for baking tacos presenting a wave-like structure, with the wave troughs being suited to receive tacos for baking. The wave-like structure serves to position the tacos in order to facilitate their filling and serving.

The document DE 43 01 806 A relates to a cooker for cooking food comprising among others a perforated basket suitable to be hung into a trough-shaped container. The perforated basket is made up of a flat material provided with apertures and has a trapezoid cross section. The perforated basket is provided with a multitude of openings, with the dimension of the openings depending on the food to be cooked. As is the case with many conventional cooking containers, the perforated bottom of the basket is flat.

### SUMMARY

It is an object to further develop the generic container so as to overcome the disadvantages of the state of the art, in particular to ensure an improved and homogenous heat input, to prevent the accumulation of fat, in particular in the middle area of the container, and/or to allow for reduced cooking times while maintaining a high cooking quality.

A container is provided for receiving cooking products to be cooked in a cooking chamber. A substantially circumferential upper rim is provided, sidewalls are provided, and a lower region comprising a bottom. The bottom has at least one arch which is raised, at least a portion of which is towards the center of the container. At least one bottom rib is provided.

### BRIEF DESCRIPTION OF THE DRAWINGS

FIG. 1 is a lateral view of the longitudinal side of a container; and

FIG. 2 is a top view of a container.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

According to the preferred embodiment, the bottom comprises at least one arch which is especially raised particularly in a continuous manner towards the center of the container, and a lower region comprises at least one bottom rib particularly extending over a width of the lower region.

The arch preferably has a cross-section, particularly in a longitudinal and/or transverse extension of the container, in the form of a circular or elliptical arc section or an obtuse angle.

Moreover, the arch presents the form of a spherical segment, a segment of a flattened cone or a flattened pyramid, and in particular has a convex form.

A plurality of bottom ribs may be present, with these bottom ribs being arranged in a manner to be spaced from each other, in particular essentially spaced in parallel.

In another embodiment, the container essentially comprises a three-dimensional piece of wire mesh, in particular for forming the bottom and/or the sidewalls.

The preferred embodiment further provides a container in the form of an upwardly open hanging tray having an upper circumferential rim for sliding along rails in a longitudinal and/or transverse direction, like rails of a rack on the walls of a cooking chamber.

Finally, the container may be provided with a handle preferably suitable to be mounted to the container in a removable manner by form-fit and/or force-lock.

Thus, preferred embodiment relies on the astonishing perception that the use of an arch which is raised inwards, towards the center of the container, in particular in connection with bottom ribs, allows for an essentially improved, namely more efficient and homogenous heat input in the cooking goods, which permits an improvement of the cooking quality while reducing the cooking time. Surprisingly, it also has been found to be particularly advantageous that with the described arch of the container bottom in the center of the container a sufficient air circulation is ensured even in the middle area of the container where the loading height is essentially lower in the middle than in the surrounding peripheral regions, and the accumulation of fat as is frequently seen with conventional containers is prevented.

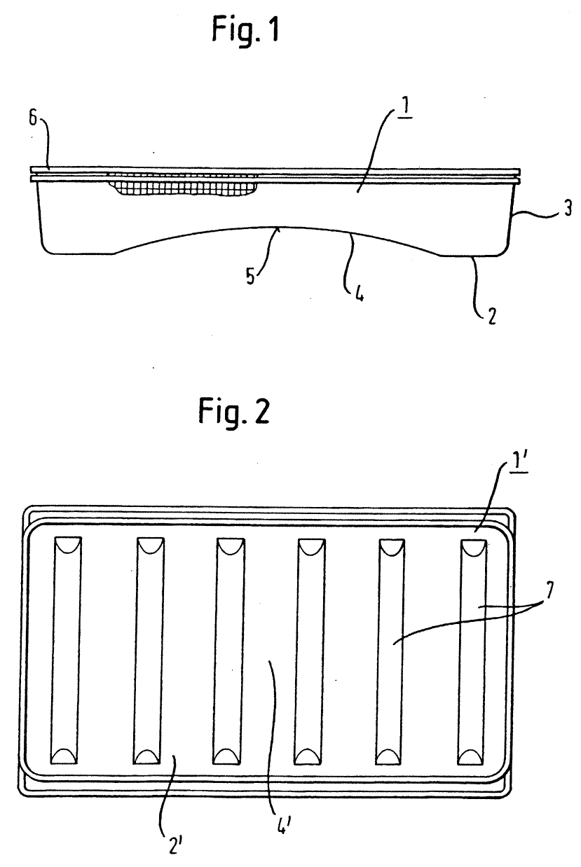

FIG. 1 shows an embodiment of a container 1 for receiving cooking products which are to be cooked, particularly cooked to completion, such as pre-blanched deep frozen French fries, potato croquettes, potato balls, potato wedges or the like, with the container being formed as a substantially rectangular container whose bottom 2 adjoins substantially vertical side walls 3 and comprising in its inner area an arch 4 which is raised in a continuous manner towards the center of the container. The sidewalls extending from the bottom 2 have a face height of about 40 to about 60 mm, for instance. Even at its highest point 5, the arch 4 of the container bottom 2 is far enough from the surface defined by the circumferential rim 6 to allow for a sufficient loading with food also in that area. The circumferential rim 6, for instance, allows a sliding of the container 1 in a longitudinal and/or transverse direction, respectively, along rails inside a not shown cooking chamber of an oven in which hot air may be circulated for cooking.

FIG. 2 is a top view of a container 1′ following FIG. 1. In addition to the arch 4′, six spaced parallel ribs or projections 7 preferably protruding upwardly are formed in the bottom surface 2′. The bottom ribs 7 result in a significant enlargement of the cooking surface and, moreover, they reduce the surface of the cooking products which come into in contact with the support. Air swirls are generated on the bottom surface 2′, in particular also by means of the bottom ribs 7, which allow for an improved air circulation and hence also for a satisfying cooking result.

The illustrated embodiments of a container ensure a homogenous cooking to completion and browning, respectively, while preventing a “roast effect” as well as the accumulation of an excessive amount of frying fat between the food items inside the container.

While a preferred embodiment has been illustrated and described in detail in the drawings and foregoing description, the same is to be considered as illustrative and not restrictive in character, it being understood that only the preferred embodiment has been shown and described and that all changes and modifications that come with the spirit of the invention both now or in the future are desired to be protected.

We claim as our invention:

1. A container for receiving cooking products which are to be cooked in a cooking chamber, and which is suitable to be impinged upon by at least one of circulating hot air and steam, comprising:
a substantially circumferential upper rim, a lower region which is relatively lower than said rim and comprising a bottom and sidewalls;
the bottom comprising at least one arch which is raised; and
the lower region comprising at least one bottom rib.

2. A container according to claim 1 wherein the at least one arch is raised towards a center of the container.

3. A container according to claim 2 wherein the at least one arch is raised in a substantially continuous manner.

4. A container according to claim 1 wherein the bottom rib is extending over a width of the lower region.

5. A container according to claim 1 wherein the arch has a cross-section in a form of at least one of a circular arc section, elliptical arc section, and an obtuse angle.

6. A container according to claim 5 wherein the cross-section is at least one of a longitudinal and transverse extension of the container.

7. A container according to claim 1 wherein the arch comprises a form of at least one of a spherical segment, a segment of a flattened cone, and a flattened pyramid.

8. A container according to claim 7 wherein the arch has a convex form.

9. A container according to claim 1 wherein a plurality of bottom ribs are present, the bottom ribs being arranged spaced from each other.

10. A container according to claim 9 wherein the bottom ribs are arranged substantially parallel.

11. A container according to claim 1 wherein the container comprises a substantially three-dimensional piece of wire mesh.

12. A container according to claim 11 wherein the wire mesh forms at least one of the bottom and the sidewalls.

13. A container according to claim 1 wherein the container has a form of an upwardly open tray having an upper circumferential rim for sliding along rails in at least one of a longitudinal and a transverse direction.

14. A container according to claim 13 wherein the rails are on the walls of the cooking chamber.

15. A container according to claim 1 wherein at least one handle is mounted to the container.

16. A container according to claim 1 wherein the container is designed for a cooking of the cooking products to completion.

17. A cooking chamber container for receiving cooking products to be cooked in a cooking chamber, comprising:
a circumferential upper rim, which can be received on rails of the cooking chamber;
downwardly extending sidewalls from the circumferential upper rim;
a bottom connected to a bottom of the sidewalls, said bottom having an arch which raises in a substantially continuous manner towards a center of the bottom; and
the bottom having a plurality of upwardly extending ribs.

18. A container of claim 17 wherein the upwardly extending ribs are substantially parallel to each other and extend substantially across a width of the container, said container being in a rectangular configuration with the ribs running perpendicular to a longitudinal extent of the container.

19. A container of claim 17 wherein the container comprises a wire mesh.

20. A container for receiving cooking products to be cooked in a cooking chamber and suitable to be impinged upon by at least one of circulating hot air and steam, comprising:
a substantially rectangular circumferential upper rim;
sidewalls downwardly extending from the upper rim;
a bottom connected to the sidewalls;
the bottom comprising at least one upwardly curved section forming a raised portion of the bottom, at least a part of the raised portion being at an approximate center of the container; and
the bottom having a plurality of upwardly extending structures so that at least a portion of the cooking products rest at least partially on the upwardly extending structures and allowing grease which drips form the cooking products to flow between the upwardly extending structures and to flow away from the upwardly curved section.
